(19) United States
(12) Patent Application Publication
(10) Pub. No.: US 2004/0098613 A1
(43) Pub. Date: May 20, 2004

(54) Software protection system and method

(76) Inventors: Juan Jose Schiavoni, Buenos Aires City (AR); Fabian Armando Belloni, Don Bosco (AR); Gabriel Edgardo Scochet, Villa Madero (AR); Dario Javier Semino, Burzaco (AR)

Correspondence Address: BAKER & HOSTETLER LLP, Washington Square, Suite 1100, 1050 Connecticut Avenue, N.W., WASHINGTON, DC, 20036, US

(21) Appl. No.: 10/714,915

(22) Filed: Nov. 18, 2003

(30) Foreign Application Priority Data
Nov. 19, 2002 (AR) P020104434

(51) Int. Cl. H04L 9/00

(52) U.S. Cl. 713/200

(57) ABSTRACT

A system and method for preventing a computer program from being used, cracked, copied and duplicated without authorization, wherein the system comprises an outer protection device that is connectable to a port of a computer and contains, stored therein, at least a portion of the program while a remaining portion of the program is for storing into the computer, and the program is executed by executing the two portions of the program by the computer and the protection device by sharing the memory and resources of the computer.

### BACKGROUND OF THE INVENTION

1. Field of the Invention

The present invention relates to a new system and method for preventing software, such as a computer program, from being used, cracked copied and/or duplicated without authorization, wherein the system is based in the use of an external protection or key device containing at least one portion of the program under uncrackable conditions, wherein the protection device may be connected to a computer and the device is permitted to share a memory and/or resources of the computer to interchange data between the device and the computer in a manner that the interchanged data protected against cracking.

2. Description of the Prior Art

With the increasing use of the computer systems and personal computers the software piracy has been an increasing concern for manufacturers and designers. While laws ruling the punishments of non authorized use of computer programs have been enacted in most of the countries, the illegal use of software is still a common practice. To make the situation worse the Internet, while useful for promoting and selling products, is now a powerful tool for distribution of pirate copies of programs and patches for eliminating the protection of software.

None of the devices and methods today available in the market have been successful in efficiently solving this problem. When new methods and systems had been developed many others were created for violating and/or cracking the same.

Some of the protecting systems include a user key that must be entered before starting the execution of the program but such a key is easily uncovered.

There are other external devices, like the ones known as dongles that are disclosed, for instance, in U.S. Pat. No. 4,609,777 and U.S. Pat. No. 4,685,055, that store key numbers which causes these devices to be necessarily connected to the computer to enable the execution of the program. This protection consists of only one simple conditional jump or hop in the machine code of the protected program, which jump can be easily replaced by a cracker having scant skillfulness in the art.

With the increased processing speed in the computers new methods, like packing, have been developed, including encrypting the machine code of the protected program. The main object of these methods is to protect the machine code against the reverse engineering. However since the code must be stored in the RAM memory of the computer for execution thereof the complete unencrypted code can be obtained by copying the content of the RAM into a file. A similar method is disclosed by U.S. Pat. No. 5,530,752.

With the increasing capacity of external devices for storing information and for processing, like the dongles, one can find patents like GB 2,149,944 wherein the external devices are employed to store part of the program code that may be or not encrypted or for desencrypting parts of the code that are encrypted and stored in the computer. Thus, without the device connected to the computer the complete code can not be obtained for execution of the program, therefore the program is protected against use without authorization. However, while the complete code can not be obtained in its normal distribution means, in order that the code be interpreted by the computer the code must be desencrypted and stored into the RAM and it is here where the program is unprotected and is finally cracked. Encrypting and desencrypting are carried out during the execution of the program.

The above mentioned methods are very weak as protection mechanisms because they do not take into account that the RAM memory is easily accessed.

Other methods that are different from the above are the methods that store and execute parts of the program under protection into a device outside the computer. Therefore, the program needs of the outer device for execution thus offering a protection against the non authorized use thereof. In addition the cracker has no access to such parts of the program and, therefore he/she is not able to carry out reverse engineering.

Other methods based in the above concept are the ones disclosed in EP 0 266 748; U.S. Pat. No. 4,817,140; GB 2,122,777; U.S. Pat. No. 4,634,807; GB2,163,577; U.S. Pat. No. 5,754,646; U.S. Pat. No. 6,266,416 and US published. Patent Application No. 20010056539. These methods employ an outer or external device connected to the computer that is executing the program under protection. Some methods execute part of the protected code in the device and other methods unencrypt and execute parts of the protected code in the device. For offering more security during the communication some methods encrypt the information interchanged between the computer and the outer device. In all these methods the outer device operates like a “black box” to which parameters are fed and from which results are obtained. The outer device executes a subroutine that is prevented from accessing to an outer variable or subroutine. This subroutine should be selected in a manner that the parameters and results thereof can not be inferred.

The above methods are based in the concept that a program is protected if part of the program is executed outside the computer, in a safety environment, to prevent reverse engineering. However these methods do not take into account an important matter that is that while the cracker does not know what is being executed into the device, and while the code in the device can not be deduced, the cracker may store all the parameters and their corresponding results to draft a table containing such information in order to replace the outer device and crack the program. The protection given by these devices are thus not efficient as long as the device has no access to the memory and/or the resources of computer and there are no call instructions to outer functions and subroutines.

U.S. Pat. Nos. 6,009,543 and 6,343,280 disclose other methods like the above but in a net architecture. Differing from the above U.S. Pat. No. 6,343,280 discloses the copying of the computer RAM and, in addition, the user that is executing the program must provide an access key to a device named “License server” that is housed in the server and that will execute the program under protection when so required by the application executed by the client. The license server is like a black box receiving parameters and giving results back which parameters and results are copied from the computer memory. While the number of parameters and results are higher than the ones of the prior methods, the “license server” method can not perform call instructions to outer functions or subroutines during the execution of the program under protection. The computer memory and/or the resources of the computer is/are not shared by the outer protection device and the computer. While the drafting of a table for cracking the device is somewhat more difficult as compared to the above methods the table can be effectively constructed on the basis of the interchanged parameters and results.

There are at least three aspects that cause this method to be unfeasible for carrying out with an outer device. First, since up to 4 Gb of RAM may be directed by an application it is necessary that the license server has this memory capacity or at least the same memory capacity of the computer where the program is being executed in order to be capable of making a copy of the memory as required by the method. Thus, this causes the license server to be constructed in a device more costly than a device employing a micro-controller because its RAM has a capacity below 4 Gb. In like manner, in the future, as the computer memories increase their capacities the license server must increase its memory capacity.

Second, the only one protection provided by this method to several users is the requirements of entering an access key to the license server to start its execution. Thus, a cracker can easily get an access key to have the required authorization to use the program. Third, since the number of users (licenses) authorized to use the program simultaneously is restricted by the IP address, a PROXY or ROUTER connected to the net containing the “license server” may be used for permitting an unlimited number of users the access with the same IP.

In view of the foregoing it would be desirable to have a protection system and method that comply with minimal requirements like preventing the partial or total non authorized execution of a protected computer program; protecting the program against reverse engineering; preventing the protection from being cracked; having a configuration for use in standard computers; permitting the distribution of the protected program via the normal channels like Internet, CD-ROM, soft disc, etc.; permitting the updating of the protected program.

### SUMMARY OF THE INVENTION

It is therefore an object of the invention to provide a system and method for preventing a computer program from being used, cracked, copied and duplicated without authorization, wherein the system comprises an outer protection device that is connectable to a port of a computer and contains, stored therein, at least a portion of the program while a remaining portion of the program is for storing into the computer, and the program is executed by executing the two portions of the program by the computer and the protection device by sharing the memory and resources of the computer.

It is still another object of the invention to provide a software protection system for use in a computer having a memory, the system comprising a protection device, such as a tamper proof device, connectable to the computer; a computer program having at least a first portion thereof to be stored in the computer and at least a second portion thereof stored in the protection device, wherein the program may include timer means for providing a limited period of time for using the program; a flow of I/O communications between the computer and the protection device; and means in the protection device for executing the second portion of the program contained in the device, wherein the execution of the second portion of the program is carried out by sharing the memory and/or resources of the computer, and wherein the computer and the protection device operate together and by using the first and second portions of the computer program to execute the computing program, wherein the first portion of the computer program may comprise a plurality of first program modules and the second portion of the computer program may comprise a plurality of second program modules, wherein the first program modules include call instructions for execution of the second modules in the protection device, and wherein the second modules contain control transfer instructions for directing the execution of the program to the first modules in the computer and/or between modules in the protection device, and wherein the protecting device comprises a physically secure microprocessor, a volatile memory and a non volatile memory having the second program modules stored therein, the non volatile memory being non readable from outside the device, and wherein the second program modules may be encrypted and may be desencrypted for storing in the protection device, and wherein the computer program may be provided with interface means, such as an interface program, for providing a communication flow between the computer and the protection device, and wherein the computer program under protection is a program used in a under-license net wherein the number of programs to be executed in the net is restricted.

It is a further object of the present invention to provide a software protection system for use in a computer having a memory, the system comprising a protection device connectable to the computer and a computer program having at least a first portion thereof for storing into the computer and at least a second portion thereof stored in the protection device, wherein the computer memory and/or the resources of the computer is/are shared by the protection device and the computer at least during the execution of the second program portion stored in the protection device, and wherein the second portion of the program may comprise modules of the machine code of the program, and the protection device comprises at least one physically secure microprocessor, a volatile memory and a non volatile memory; and communication means may be provided between the computer and the protection device; and wherein an interface program may be provided for providing an interface between the computer and the protection device.

It is a further object of the present invention to provide a method for protecting a computer program against the unauthorized copy and/or use thereof, the method comprising the steps of providing a protection device for connecting to a computer having a memory; providing the computer program with at least a first portion thereof for storing into the computer and at least a second portion thereof stored in the protection device; sharing the computer memory and/or the resources of the computer between the computer and the protection device; and operating the protection device and the computer together to execute the computer program, whereby the first and second portions of the computer program are executed by sharing computer resources, wherein the step of providing the computer program with at least a first portion for storing into the computer and at least a second portion stored in the protection device may comprise forming the first portion of the program by removing from the computer program at least one module consisting of a machine code, with the at least one removed module being stored into the protection device to form the second portion of the program, and wherein the method may comprise also storing in the first portion of the program a calling module including function calls for the execution of the at least one module that was removed from the program and stored in the protection device, wherein the calling module replaces the at least one module removed from the program, and wherein the step of executing the computer program may comprise executing the first portion of the program in the computer, operating the calling module for executing at least one module of the second portion of the program in the protection device, and interchanging communications in a manner to prevent the cracking thereof, and wherein the modules in the protection device may include instructions for interrupting and routing the execution of the computer program, instructions acceding to external variables and instructions that are combined in a complex manner to prevent the cracking thereof, and wherein the step of forming the first portion of the program by removing from the computer program at least one module may comprise removing a plurality of modules for storing into the protection device to form the second portion of the program, wherein a plurality of calling modules are stored in the first portion of the program for replacing the modules removed therefrom, and the step of operating the protection device and the computer may comprise the execution of control transfer instructions in the device for directing the execution of the program to the first modules in the computer and/or between modules in the protection device and wherein the step of removing modules from the computer program may comprise selecting the modules containing at least control transfer instructions, instructions accessing to external variables and non-inferable instructions and removing the modules, and wherein the modules may be automatically or manually removed, and wherein the step of operating the protection device and the computer together to execute the computer program may comprise operating the protection device to execute the portion of the program contained therein by emulating one of the computer processor and the virtual machines JAVA and NET.

It is still another object of the present invention to provide a method for protecting computer programs against the non authorized use thereof, wherein the method comprises the execution of selected parts of the machine code of the program to be protected, wherein the program parts or portions are executed within a secure environment comprising an outer protection device, and wherein the computer resources and/or memory are shared with the protection device in order that the protection device uses the computer resources during the execution of said parts of the machine code of the program stored into the protection device; and wherein the protection device is connected to one of the computer port, wherein the computer resources are the hardware and the operative system thereof.

It is still another object of the present invention to provide a method for protecting computer programs against the non authorized use thereof, wherein the method may be implemented for protecting processes control systems, equipment control systems, programs for cellular telephony, programs for portable computers, programs for embedded equipment, general computer programs and general controllers.

It is still another object of the present invention to provide a method for protecting computer programs against the non authorized use thereof, wherein the method comprises the steps of removing portions, named modules, of the machine code of the program to be protected; storing the modules into a protection device comprising at least one physically secure microprocessor, a volatile memory and a non volatile memory; establishing a communication between the computer and the protection device; replacing the machine code of the removed modules by call instructions to execute said modules into the protection device; incorporating an interface program into the computer program, the interface program actuating in the intercommunication between the computer and the protection device; and processing the computer program between the computer and the protection device wherein the memory and/or the resources of the computer is/are shared between the computer and the protection device during the execution of the portions of the program that are stored into the protection device, and wherein the program portions may be selected and removed manually or automatically with a desired criteria and then stored into the protection device.

It is a further object of the present invention to provide a system for carrying out a method for protecting computer programs against the non authorized use thereof, wherein the system comprises a computer for executing the program under protection and for removing portions or modules of the machine code of the program; a protection device comprising at least one physically secure microprocessor, a volatile memory and a non volatile memory that is a memory non readable from outside and that is a memory for storing the removed modules; a communication means between the computer and the protection device; an interface program providing an interface between the computer and the protection device; computer resources, such as hardware and operative system, that are shared by the computer and the protection device during the execution of said modules into the protection device.

The method and system of the present invention are basically distinct from the prior art in that in the present invention the memory and resources of the computer are shared by the computer and by the protection device during the execution of at least the modules stored into the protection device; this sharing, together with the provision of control transfer instructions, such as call instructions or function calls, between different modules in the device or between the device and the computer, prevents the drafting of a table with enough data to crack the system; in addition, the portions removed from the program are stored into the protection device thus differing from the known devices that retrieve the program portions from the computer during execution making the system insecure because this information can be copied during transference thereof between the device and the computer and, if the data are encrypted. Since these portions of the program are not interchanged between the protection device and the computer and since the protection device is tamper proof, the system is uncrackable. Since encrypting/desencrypting is not necessary in the present invention, during execution of the program, the processing speed is higher in the invention.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a diagram of the system according to the invention,

FIG. 2 shows a diagrammatic operation of the system of the invention,

FIG. 3 shows a diagrammatic process of the removal of program modules according to the invention,

FIGS. 4 and 5 diagrammatically shows the storing of modules in the protection device,

FIG. 6 shows the communication between the computer and the protection device,

FIG. 7 diagrammatically shows the execution of the computer program according to the invention, and

FIG. 8 diagrammatically shows the execution of the module(s) within the protection device.

### DESCRIPTION OF THE PREFERRED EMBODIMENTS

Before entering into the description of the figures it may be useful to remark that the method of the invention includes the removal of the executing files of the computer program or software to be protected. More particularly, previously selected parts or portions of the machine code of the program are removed from the program in a manner that the these portions contain at least instructions that interrupt and route the execution of the program, instructions accessing to outer variables and instructions that when grouped are mostly difficult to be inferred or cracked. The removal of these modules may be carried out manually or automatically.

The removed modules are individually identified and stored in the protection device as well as replaced in the program by a call module or call instruction to execute the corresponding module in the device. In addition, a “trash” module or filler may be employed for complement this replacement. Thus a public portion of the program stored into the computer and a secret portion of the program stored into the protection device is obtained. Therefore, the user can only execute the program if the protection device is connected to a port of the computer and the restricted time of use of the program may also be provided by the inventive system and method.

When the public part of the program is executed by the user in his/her computer the system seeks if the protection device is connected or not to the computer and if connected the device is identified and the execution of the program is continued to execute the program and depending on the fact that if the program has been authorized for full or partial use thereof. When the public part of the program finds a call module or call instruction, the execution process is passed onto the protection device. The modules are then executed in the protection device. To this purpose the device receives from the computer all the registers from the processor, an offset valued of the module starting direction and the identifier of the module to be executed. The protection device gets from the module stored in its memory, which module can not be read from outside, the machine code to be executed and the operation code of the instruction is interpreted. The instruction is analyzed to see whether it interrupts or routes the execution of the program, namely CALL, JMP or JCC type instruction, and the instruction is executed. The protection device analyzes whether the instruction to be executed contains an operator housed in the computer memory or in the inner memory and it retrieves it. The instruction is executed by emulating the computer processor and the result of the execution is analyzed to see if the same must be stored or not in the computer memory or in the inner memory and the result is stored. The device again gets the machine code that is being executed and the execution is continued within the device until the module is finished or an instruction interrupting or routing the program execution is found. The protection device returns the execution to the computer by sending the updating of all of its processor registers. The execution of the public portion of the program is continued up to a new call instruction to execute a module in the device is found.

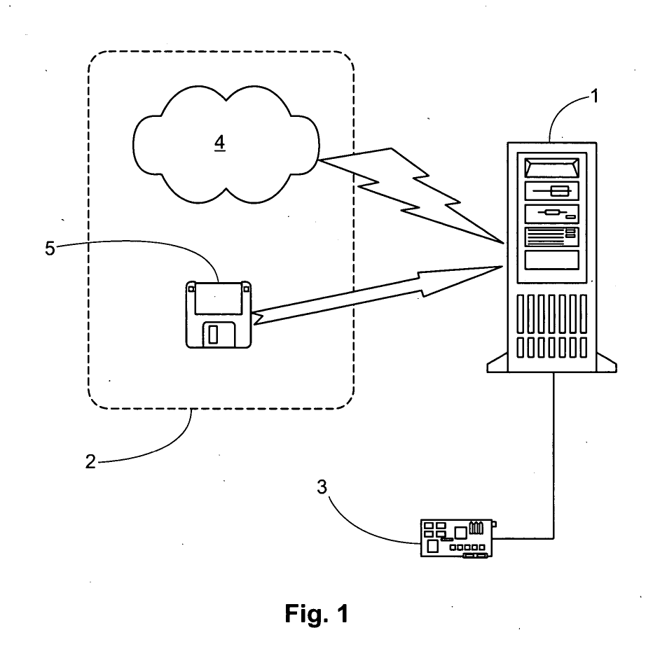

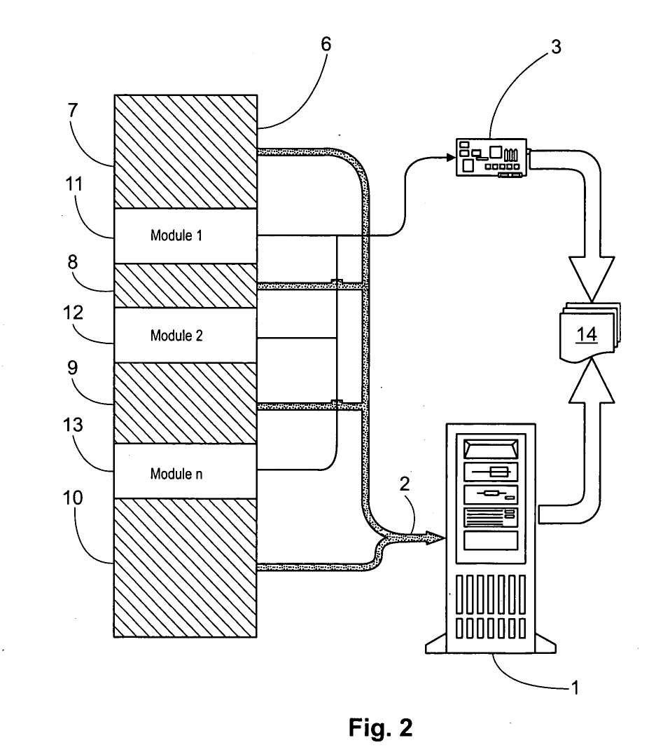

As it is shown in FIG. 1, the system of the invention requires of a personal computer PC or working station 1 that contains a public portion or first portion 2 of a computer program or software under protection 6, see FIG. 2. An outer protection device 3 is connected to one of the computer ports. The public portion or first portion of the computer program may be commercialized through a LAN or WAN net as well as by Internet 4′, or through any other data storing medium 5 either magnetic, optical, etc.

The distribution of the public portion of the program by Internet may be free, however, since a secret portion, modules 1, 2, . . . n (FIG. 2), of the program under protection is stored in the protection device a copy of the entire program can not be obtained through this way. In addition, since the partial or total execution of the program requires of the protection device the use of the program is restricted.

FIG. 2 diagrammatically shows the operation of the system and method of the invention. The program under protection 6, named “App.exe”, is divided into two parts or portions, the first portion or public portion 2 comprising the first program portions 7, 8, 9 and 10, and a secret or second portion comprising second program portions or modules 11, 12 and 13 stored into device 3.

The secret modules, namely module 1, indicated with reference number 11, module 2, indicated with reference number 12 and module n, indicated with reference number 13, of program 6 are removed and stored into protection device 3. The remaining portions of the program, namely the portions indicated by reference numbers 7, 8, 9 and 10, forming part of the public portion 2 of the program, namely “App.exe_pc”, that is App.exe without modules 1, 2, . . . n., are stored into the computer 1 wherein the program is to be executed. Program App.exe 14 is obtained by the joining of the modules contained in the protection device, namely modules 1, 2, . . . n, and the remaining portions of the program “App.exe_pc” contained in the computer.

From the above it is clear that the computer program can not be executed without the protection device or, alternatively, only part of the program can be executed depending of the portions of the program that have been removed. The partial execution of the program may be useful to put in practice evaluation versions of the program, which versions are frequently used for promotion and commercialization purposes. Thus a “taste-and-purchase” version of the program may be provided because the entire program can not be used without the protection device which must be purchased to the manufacturer of the program.

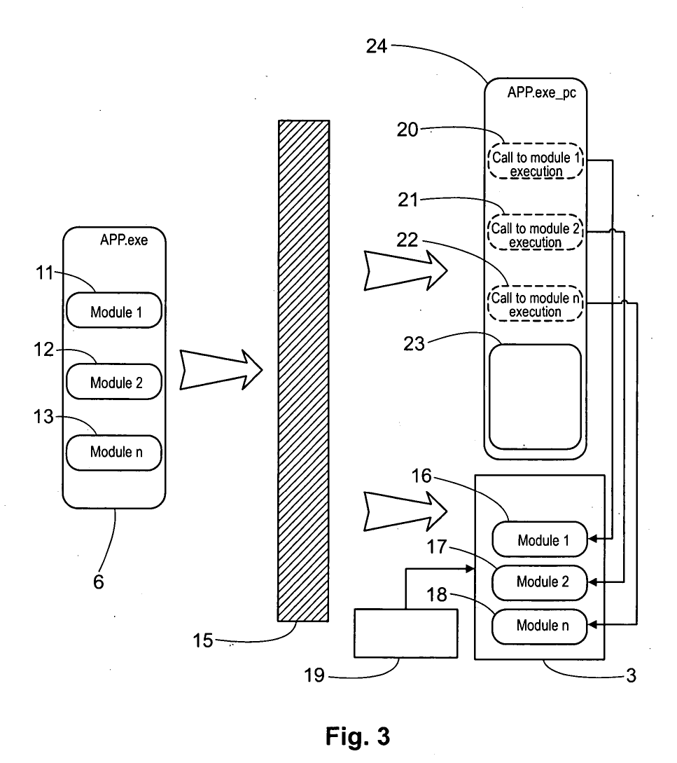

FIG. 3 shows the step of removing the portions of the machine code or modules of the program to be protected, which removal may be carried out once the program is finished because the inventive method is not implemented during the development of the program and it does not require of the APIS, namely application programming interface, routines, protocols, and tools for constructing computer programs. This step is comprised of the manual or automatic selection of modules 11, 12, and 13. The software manufacturer may manually select modules 11, 12 and 13 which will be executed only if the protection device is connected to the computer. Thus, partially executing versions or evaluation versions may be obtained. The selected module must not be a function or subroutine and it may use any variable in the memory of the computer as well as it may contain instructions for calling outer variables.

The automatic selection of modules 11, 12 and 13 permits the software manufacturer to easily implement a secure system to prevent the program from being executed without the protection device.

In any event the selected modules 11, 12, 13 are removed and then stored, as represented by diagrammatic block 15, into the protection device. Before storing, a key 19 must be entered to permit the loading of said modules and the modules are stored as modules indicated by reference numbers 16, 17, 18 in FIG. 3, into device 3. The intent to access to key 19 is permitted up to a maximum of three times and each module stored in the protection device is identified by a number that makes the module distinct from the others. The storing operation may include an encrypting process for encrypting each module only once before storing into the device, which module is then desencrypted and stored into the device.

Removed modules 1, 2, . . . n, are replaced by call modules, such as call instructions or function calls 20, 21, 22 for calling the execution of modules 16, 17, 18 in the protection device. Those locations of program APP.exe from which the modules have been removed are refilled with a corresponding call instruction 20, 21, 22, for execution within device 3. If sizes do not match, a complement code filler, as stated above, may also be used.

An additional program 23 is included into the machine code of the program under protection, which additional program 23 actuates as a communication interface between the protection device and the computer. The machine code of original program 6 “APP.exe” without portions or modules 11, 12, 13, with additional program 23 is identified as “APP.exe.pc” and this is the public part of the program, now referenced with number 24, now in the computer and equivalent to program 2.

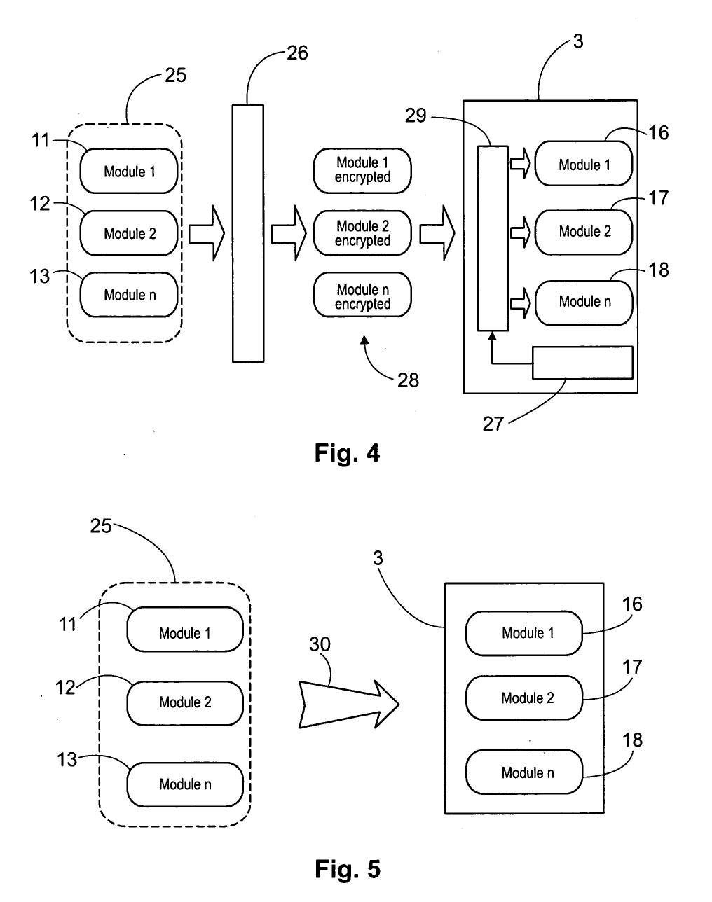

FIG. 4 diagrammatically shows the storing of modules into device 3, wherein the loading may include an encrypting/desencrypting of each module whereby the user of the inventive system is provided with a safety method for updating the software. This is important for many situations, let us assume that a software company issues a new version of a software protected under the inventive system, and after some time the company is aware that the program has an inconvenient just in a part of the code that is stored in the protection device. Under these circumstances the company may replace the affected module either by directly replacing the protection device or by replacing the module into the device. For replacing the module the company should make the machine code publicly accessible to their users in order that they can access the device to unload the updating program. By using the encrypted modules the company may provide the users with the new encrypted module without running the risk of having the module cracked by non authorized persons.

The removed modules indicated within block 25 are encrypted only once into an encrypting unit 26 having a desencrypting key that is stored in the protection device. Encrypted modules 28 are desencrypted by desencrypting unit 29 that is within device 3 and are stored into device 3.

FIG. 5 diagrammatically shows the storing 30 of modules into device 3 without encrypting. This is possible because the storing is made in the software company by using a secret machine code of each module.

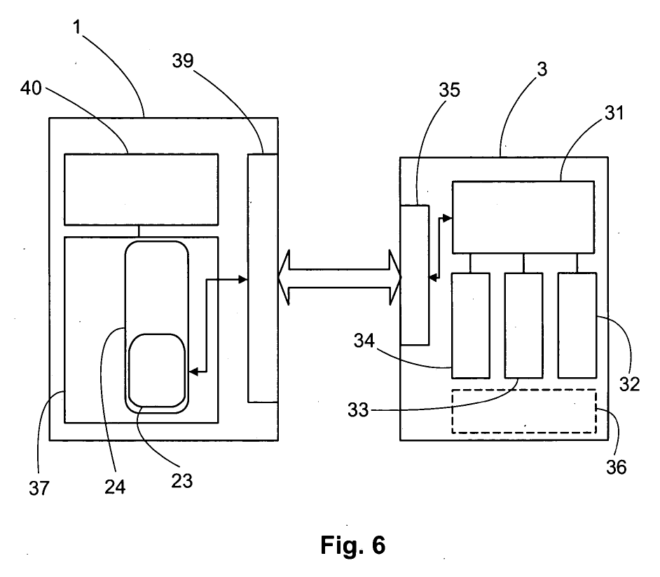

FIG. 6 shows the communication between computer 1 and device 3, wherein the minimal configuration of the protection device. This device may comprise a physically secure microprocessor 31, ROM memory or Flash EPROM 32, EEPROM memory 33, RAM memory 34, communication port 35, and it may contain or not a cryptographic co-processor 36.

During the execution of the program under protection the operative system of the computer loads the public part of program 24 APP.exe_pc into memory 37 for execution. When APP.exe_pc requires of the execution of part of the code that is in device 3 the APP.exe_pc uses the interface 23 to send the corresponding command to device 3 through communication port 39. Device 3 accesses to subroutines, registers and the computer memory via interface 23 and port 35 and once the execution of the module is finished, the execution control of the program is returned to the computer processor 40 and to the public part of the program 24 APP.exe_pc.

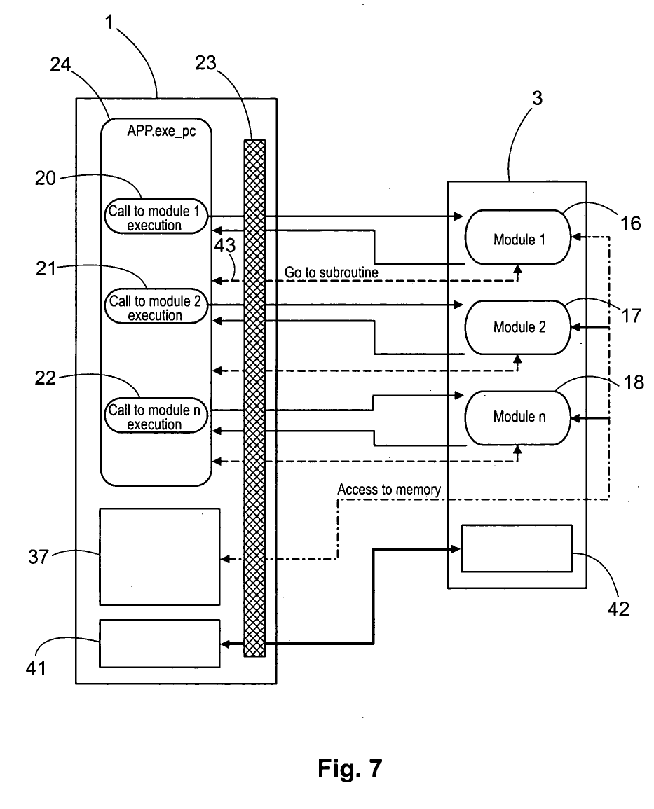

FIG. 7 shows an scheme of the execution of the program under protection with the present invention. The method starts in the computer with the execution of the public part of the program 24 APP.exe_pc and follows in the computer until a call instruction 20, 21, 22 for execution of one of modules 16, 17, 18 in device 3 is found. In this moment the registers of processor 41 and the execution process is transferred to device 3 via interface 23 and communication ports 39, 35.

During execution of module 16, 17, 18 device 3 may access to computer memory 37 for retrieving or storing information if so required or may follow through functions or subroutines that are within the computer to then follow with the execution. Each time an instruction directing the execution to a subroutine 43 is found device 3 sends to computer 1 the registers of processor 41 as they have been previously modified 42. In this way the execution of the subroutine within the computer is correctly carried out and then the execution returns to the protection device. Once the execution of module 16, 17, 18 is finished the execution is returned to the computer and the registers modified or not by the processor, depending of the executed machine code, are also returned to the computer.

The invention may be better understood with reference to the following example which is not limitative or restrictive of the scope of protection. On the contrary, it must be clearly understood that many other embodiments, modifications and alterations equivalent to the elements of the invention may be suggested by persons skilled in the art after reading the present description, without departing from the spirit of the present invention and/or the scope of the appended claims.

### EXAMPLE

### Method and System of Protection of an Embroidering Program

A first portion, that is some modules of the program, has been removed from the broidering program and said modules were stored in a protection device according to the invention. Thus, a first portion of the program, namely the public part or modules of the program executed in the computer, and a second portion of the program, namely secret modules of the program executed in the protection device, have been obtained.

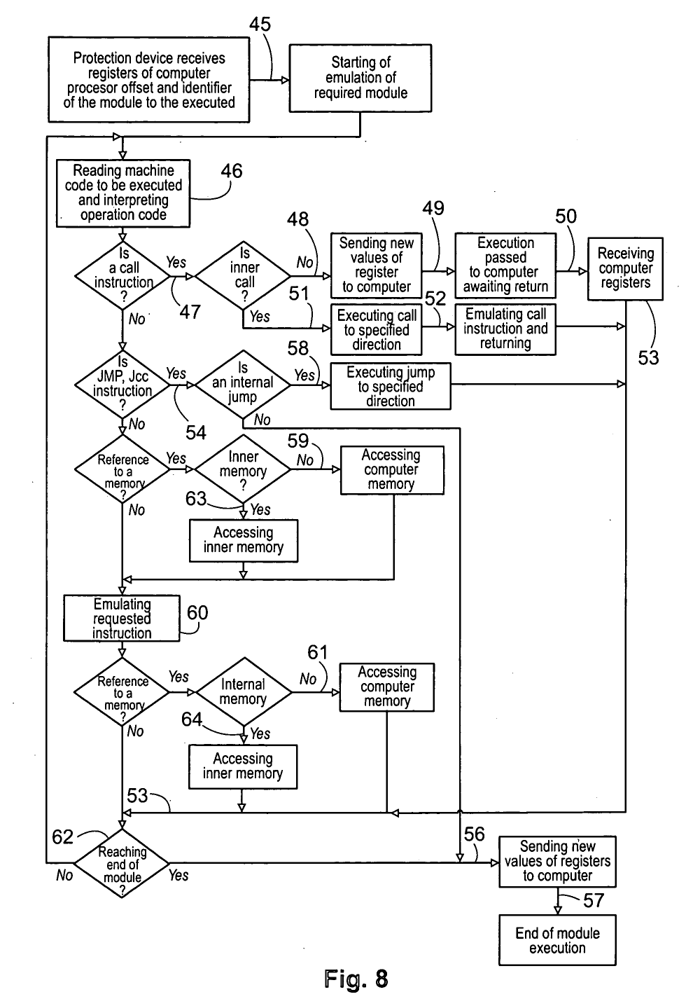

FIG. 8 shows a flowchart of the inventive method and the execution of the module within the protection device. When the execution of the program within the computer finds a call instruction to execute of one of the modules in the protection device the additional program actuating as an interface sends a command to the protection device for continuing with the execution. The device receives from the computer and via the interface and the corresponding computer ports, the processor registers, an offset instruction that indicates the direction that the execution must follow in the module and the identifier of the module to be executed.

The protection device reads the machine code to be executed and that is stored as a module and the device interprets the operation code for determining the instruction that must be emulated. If the operation code identifies a call instruction 47 it must determine whether a function or an inner or outer subroutine must be called in the protection device. If it is an outer subroutine or function 48, the device sends to the computer the new values of the registers and the execution is passed on to the computer with the device remaining awaiting for return 49. The computer executes the requested subroutine or function and then the execution is returned to the protection device which receives the registers from processor 50 and continues the execution of module 53.

If the operation code identifies a JMP instruction 54, either conditional or not, it is determined whether the a hop or jump is made in an internal or external direction regarding the protection device. If it is an external jump 55, the protection device sends to the computer the new values of registers 56, it finishes the execution of the module and the execution is passed on to the computer 57. If it is an internal jump 58 the instruction is carried out and the execution then continues in module 53.

If in the instruction to be emulated some operator makes reference to the computer memory, it must be determined whether this reference is to the inner memory of device 63 or to the computer memory 59. If reference is made to the computer memory the protection device access to the computer memory via the communication interface, retrieves the required data and continues with the emulation of the required instruction 60. In the event the operators do not make reference to a memory, the device continues with the emulation of the required instruction 60.

When the emulation of the instruction is finished and if the result must be stored into the computer memory 61 or in the inner memory 64, the protection device access to the memory and then continues with the execution of the module 53. When reaching the end of the module the protection device send to the computer the new values of the registers 56, finishes the execution of the module and the execution is passed to the computer 57 with the device remaining to wait for a new request for execution of one of the modules. Otherwise 62, the device reads the machine code to be executed and interprets the operation code 46 to continue with the execution of the module. The execution of the program has been carried out in a shared manner, between the computer and the protection device, wherein the resources of the computer have been shared during the execution of the modules in the protection device.

As it is clear from the above detailed description the present invention provides secure means for preventing the inverse or reverse engineering for cracking software.

By the present invention portions or parts of the machine code of the program under protection, namely modules, are removed from the program and stored into the memory of the protection device. Said modules are replaced in the program by call instruction to execute said modules in the device and, if room is available in the location where the module has been removed from, also “trash” modules may be used as explained above. The memory of the device is non readable from outside and the resources of the computer are shared by the device during the execution of the machine code into said protection device. The machine code is the lowest level language of the computer and represents instructions and data of an executed by the computer.

The method of the invention comprises the steps of:

removing one or more portions of the machine code of the program to be protected, these removed portions are called modules, which modules are selected in a manner that they contain at least instructions for interrupting and directing or routing the execution of the program, instructions accessing outer variables or instructions that when grouped are mostly difficult to be inferred or cracked;

storing the removed modules into a protection device that is non readable from outside;

replacing said removed modules in the program by call modules or call instructions for calling to the execution of the modules that are stored into the device;

executing the modules in the computer, namely the “public portion” of the program, with at least part of the modules containing the call instructions to execute the modules in the device;

executing the modules in the protection device by using the computer resources and the computer memory or by executing functions or subroutines into this memory or by executing the modules into the device with the execution of functions or subroutines stored in other modules in the device;

returning the execution to the computer once executed the module.

In this way a public portion of the program stored and executed in the computer and a secret portion of the program stored and executed in the protection device are obtained. The removed modules are not necessary functions or subroutines for receiving parameters and obtaining results. This is achieved thanks to the protection device that processes the program in a shared manner with the computer process, that is by emulating this processor, thus the program can be partially or entirely executed if the protection device is installed.

In order to execute the program between the computer and the device the computer memory and its internal registers are shared with the protection device. This makes the device is not a black box with an input and an output but it is provided with a plurality inputs and outputs directly interacting with the computer resources during the execution of the program under protection. In addition the outputs may be re-used as inputs.

The subroutines or function calls not only are carried out in the computer but also outer subroutines and call instructions are carried out in the protection device returning to the computer for the execution of same. Also there may be inner call functions that may be or not in other module of the same protection device. Also, an execution call may be provided not only from the starting of a determined module but also from any part of same.

As a result the cracker not only is unable of seeing or inferring the code stored and executed in the device but also is unable of constructing a table because there are infinite data inputs and outputs from the protection device and therefore there are indefinite parameters/results relationships that are also interrelated to each other. This is why the encrypting of the communication is unnecessary. While the communication is encrypted the same must be desencrypted during execution and here is the place where the protection mechanism is vulnerable.

Since each protection device and each protected program have an unique identifier for identifying to each other, with the present invention several programs may be executed simultaneously always and when the protection device is connected to the computer port.

The method of protecting programs against the non authorized use or copy thereof provides the possibility of using the program during a restricted period of time that may be pre-established. The main object of the present system and method is to prevent the copy and unauthorized use of a computer program and to prevent the construction of a data table for cracking a software or program as well as to protect the license use of a program for use in a net wherein the system may be stored in a computer of said net.

Some applications of the invention comprise the use in process control, equipment control, programs for control of cell telephony, programs of portable computers, programs for embedded equipment and computer programs in general.

While preferred embodiments of the present invention have been illustrated and described, it will be obvious to those skilled in the art that various changes and modifications may be made therein without departing from the scope of the invention as defined in the appended claims.

We claim:

1. A software protection system for use in a computer having a memory, the system comprising:
a protection device connectable to the computer;
a computer program having at least a first portion thereof to be stored in the computer and at least a second portion thereof stored in the protection device;
a flow of I/O communications between the computer and the protection device;
means in the protection device for executing the second portion of the program contained in the device, wherein the execution of the second portion of the program is carried out by sharing the memory and resources of the computer, and wherein the computer and the protection device operate together and by using the first and second portions of the computer program to execute the computing program.

2. The system of claim 1, wherein the first portion of the computer program comprises a plurality of first program modules and the second portion of the computer program comprises a plurality of second program modules, wherein the first program modules include call instructions for execution of the second modules in the protection device.

3. The system of claim 2, wherein the second modules contain control transfer instructions for directing the execution of the program to the first modules in the computer and/or between modules in the protection device.

4. The system of claim 1, wherein the protecting device comprises a physically secure microprocessor, a volatile memory and a non volatile memory having the, second program modules stored therein, the non volatile memory being non readable from outside the device.

5. The system of claim 2, wherein the second program modules are encrypted and are desencrypted for storing in the protection device.

6. A software protection system for use in a computer having a memory, the system comprising:
a protection device connectable to the computer;
a computer program having at least a first portion thereof for storing into the computer and at least a second portion thereof stored in the protection device, wherein the memory and resources of the computer are shared by the protection device and the computer at least during the execution of the second program portion stored in the protection device.

7. The system of claim 6, wherein the second portion of the program comprises modules of the machine code of the program, the protection device comprises at least one physically secure microprocessor, a volatile memory and a non volatile memory; communication means between the computer and the protection device; and an interface program providing an interface between the computer and the protection device.

8. The system of claim 1, wherein the protection device is a tamper proof device.

9. The system of claim 1, wherein the computer program includes timer means for providing a limited period of time of use of the program.

10. The system of claim 1, wherein the computer program includes interface means for providing a communication flow between the computer and the protection device.

11. The system of claim 1, wherein the computer program to be protected is a program used in a under-license net wherein the number of programs to be executed in the net is restricted.

12. A method for protecting a computer program against the unauthorized copy and/or use thereof, the method comprising:
providing a protection device for connecting to a computer having a memory;
providing the computer program with at least a first portion thereof for storing into the computer and at least a second portion thereof stored in the protection device;
sharing the memory of the computer between the computer and the protection device; and
operating the protection device and the computer together to execute the computer program, whereby the first and second portions of the computer program are executed by sharing computer resources.

13. The method of claim 12, wherein the step of providing the computer program with at least a first portion for storing into the computer and at least a second portion stored in the protection device comprises forming the first portion of the program by removing from the computer program at least one module consisting of a machine code, storing the at least one removed module into the protection device to form the second portion of the program, storing in the first portion of the program a calling module including function calls for the execution of the at least one module that was removed from the program and stored in the protection device, wherein the calling module replaces the at least one module removed from the program.

14. The method of claim 13, wherein the step of executing the computer program comprises executing the first portion of the program in the computer, operating the calling module for executing at least one module of the second portion of the program in the protection device, and interchanging communications in a manner to prevent the cracking thereof.

15. The method of claim 14, wherein the modules in the protection device include instructions for interrupting and routing the execution of the computer program, instructions acceding to external variables and instructions that are combined in a complex manner to prevent the cracking thereof.

16. The method of claim 13, wherein the step of forming the first portion of the program by removing from the computer program at least one module comprises removing a plurality of modules for storing into the protection device to form the second portion of the program, wherein a plurality of calling modules are stored in the first portion of the program for replacing the modules removed therefrom, and the step of operating the protection device and the computer comprises the execution of control transfer instructions in the device for directing the execution of the program to the first modules in the computer and/or between modules in the protection device.

17. The method of claim 16, wherein the step of removing modules from the computer program comprises selecting the modules containing at least control transfer instructions, instructions accessing to external variables and non-inferable instructions and removing the modules.

18. The method of claim 17, wherein the modules are automatically removed.

19. The method of claim 12, wherein the step of operating the protection device and the computer together to execute the computer program comprises operating the protection device to execute the portion of the program contained therein by emulating one of the computer processor and the virtual machines JAVA and NET.

20. The method of claim 12, wherein the step of providing the computer program with at least a first portion and a second portion comprises removing at least one module of a plurality of modules of the program, with the at least one module comprising the machine code of the program to be protected and being selected in a manner that that the at least one module contains at least one of instructions for interrupting and directing or routing the execution of the program, instructions accessing outer variables and instructions that when grouped are mostly difficult to be inferred or cracked; storing the removed at least one module into the protection device, the device being non readable from outside; and replacing said at least one removed module by a call module for calling to the execution of the at least one module that has been stored into the device; and the step of operating the protection device and the computer comprises executing the call modules in the computer, whereby the call instructions execute the modules in the device; and executing the at least one module in the protection device by using the memory and resources of the computer and returning the execution to the computer once the at least one module of the protection device has been executed.
